(19) United States
(12) Patent Application Publication
(10) Pub. No.: US 2011/0299720 A1
(43) Pub. Date: Dec. 8, 2011

(54) SYSTEMS AND METHODS FOR MATERIAL LAYER IDENTIFICATION THROUGH IMAGE PROCESSING

(75) Inventors: Craig Merten Nolen, San Diego, CA (US); Giovanni Laviste Denina, Moreno Valley, CA (US); Desalegne B. Teweldebrhan, Highland, CA (US); Alexander A. Balandin, Riverside, CA (US); Bir Bhanu, Riverside, CA (US)

(73) Assignee: The Regents of the University of California, Oakland, CA (US)

(21) Appl. No.: 13/052,009

(22) Filed: Mar. 18, 2011

Related U.S. Application Data
(60) Provisional application No. 61/315,343, filed on Mar. 18, 2010.

(51) Int. Cl. G06K 9/00

(52) U.S. Cl. 382/100

(57) ABSTRACT

A fast and fully automated approach for determining the number of atomic planes in layered material samples is provided. Examples of such materials may include graphene and bismuth telluride (Bi₂Te₃), and materials from the bismuth selenide (Bi₂Se₃) samples is provided. The disclosed procedure allows for in situ identification of the borders of the regions with the same number of atomic planes. The procedure is based on an image processing algorithm that employs micro-Raman calibration, light background subtraction, correction for lighting non-uniformity, and color and grayscale image processing on each pixel of a graphene image. The developed procedure may further provide a pseudo-color map that marks the single-layer and few-layer regions of the sample. Beneficially, embodiments of the developed procedure may be employed using various substrates and can be applied to materials that are mechanically exfoliated, chemically derived, or deposited on an industrial scale.

### CROSS-REFERENCE TO RELATED APPLICATIONS

This application claims the benefit of priority under 35 U.S.C. §119(e) of U.S. Provisional Application No. 61/315,343, filed on Mar. 18, 2010, and entitled “SYSTEMS AND METHODS FOR GRAPHENE IDENTIFICATION THROUGH IMAGE PROCESSING,” the entirety of which is hereby incorporated by reference and should be considered a part of this specification.

### BACKGROUND OF THE INVENTION

1. Field of the Invention

Embodiments of the present disclosure pertain to systems and methods for materials characterization and, in particular, to identification of layers in atomically thin materials, such as graphene and graphene-like exfoliated thin film materials.

2. Description of the Related Art

Graphene is a two-dimensional (2-D) crystal of sp²-bonded carbon atoms. Mechanical exfoliation of graphene has lead to the identification that graphene possesses high electronic, thermal, optical and mechanical properties. These outstanding properties make graphene a promising material for use in alternatives to complementary-metal-oxide semiconductor (CMOS) technologies. These properties may further provide improvements in electronic, interconnect, and thermal management applications employing graphene.

Unfortunately, locating and identifying regions of single and few-layer graphene regions in graphene samples is currently problematic. For example, existing methods may be limited owing to their relatively slow, expensive, and non-automated measurement procedures. As a result, these existing methods are used, practically, for counting the number of layers and quality analysis over relatively small regions (e.g., length scales on the order of a few microns) of single layer graphene (SLG) and sometimes few layer graphene (FLG) samples. These methods may also become impractical and/or inadequate for analyzing large-area graphene wafers (e.g., lateral length scales on the order of millimeters), which is practical for industrial processes. Moreover, most of these techniques provide only rough estimates of the number of atomic layers.

This difficulty in identifying the number of atomic layers of graphene is of concern because the physical characteristics of FLG are different from those of SLG. Owing to a strong dependence upon the number of atomic planes contained by the graphene, the electronic, thermal and optical properties of FLG approach those of bulk graphite as the number of atomic layers exceeds approximately ten layers. For example, SLG exhibits electron mobility in the range from approximately 40,000 cm²V⁻¹s⁻¹ to approximately 400,000 cm²V⁻¹s⁻¹ and intrinsic thermal conductivity above approximately 3000 W/mK for large, suspended flakes. In contrast, bilayer graphene (BLG) exhibits an electron mobility and intrinsic thermal conductivity that is significantly lower than FLG, with electron mobility in the range from approximately 3000²V⁻¹s⁻¹ to approximately 8000 cm²V⁻¹s⁻¹ and intrinsic thermal conductivity near approximately 2500 W/mK. The optical transparency of FLG is also a strong function of the number of layers contained within the graphene. As a result, the one-atom thickness of graphene and its optical transparency (approximately.3% absorption per layer) make graphene identification and counting the number of atomic planes in FLG extremely challenging.

Recent progress in chemical vapor deposition (CVD) growth of graphene has lead to the fabrication of large-area graphene layers that are transferable onto various insulating substrates. CVD graphene layers grown on flexible, transparent substrates have been demonstrated in sizes up to about 30 inches in their largest lateral dimension. Various other methods of graphene synthesis have also been reported. As a result, the emergence of graphene growth techniques on insulating substrates is expected in the near future, which would reduce the need to transfer graphene to the substrate. The fusion of the large-area graphene on transparent, flexible substrates with graphene-based organic light emitting diode (OLED) technology is also expected to lead to major practical applications. However, as graphene of larger areas becomes available, quality control remains as an important factor that may limit further progress in graphene research and applications of graphene and other layered materials.

### SUMMARY OF THE INVENTION

In an embodiment, a computer-implemented method for identifying a number of layers in a layered thin film material. The method comprises, under control of one or more computing devices receiving a first electronic image comprising a representation of at least a portion of a first layered thin film material in a selected color space captured under one or more selected illumination conditions. The method further comprises determining a correlation between a number of layers of the layered thin film material and a range of color component values of the selected color space. The method additionally comprises receiving a second electronic image comprising a representation of at least a portion of a second layered thin film material in the selected color space captured under the one or more selected illumination conditions, wherein the second layered thin film material comprises the same material as the first layered thin film material. The method further comprises identifying a number of layers in a selected region of the second electronic image of the second layered thin film material using the determined first correlation.

In another embodiment, a computer-implemented method for identifying a number of layers in a layered thin film material is provided. The method comprises receiving an electronic image comprising a representation of at least a portion of a first layered thin film material in a selected color space captured under one or more selected illumination conditions. The method further comprises determining an intensity range in one or more components of the selected color space that correspond to a number of layers in a second layered thin film, wherein the second layered thin film material comprises the same material as the first layered thin film material and the intensity range is determined under the one or more selected illumination conditions. The method additionally comprises identifying a number of layers in a selected region of the electronic image of the first layered thin film material using the determined intensity range.

In a further embodiment, a system for detecting a number of layers of a layered thin film material is provided. The system comprises a data store that stores one or more correlations between a number of layers of a layered thin film material and ranges of component values of a selected color space. The system further comprises a computing device in communication with the data store. The computing device may be operative to obtain the one or more correlations from the data store. The computing device may also be operative to obtain an electronic representation of the layered thin film material in the selected color space. The computing device may be further operative to identify a number of layers within a selected region of the layered thin film material of the based upon the one or more correlations.

### BRIEF DESCRIPTION OF THE DRAWINGS

FIG. 1 is an embodiment of a system for layer detection in material samples;

FIG. 2 is a flow diagram of an embodiment of a method for layer detection in material samples;

FIGS. 3A and 3B are optical micrographs illustrating images of an Si/SiO₂ substrate (3A) and a graphene material positioned on an Si/SiO₂ substrate (3B);

FIG. 4A is a Raman line scan illustrating the characteristic G peak and 2D band peak used for identification of the number of atomic planes or layers, n, in a selected region of a graphene sample;

FIG. 4B is an optical micrograph of the graphene sample from which the Raman line scan of FIG. 4A is taken (dotted line of about 12.5 μm indicates the region of the Raman line scan of FIG. 4A); white numbers label the number of atomic planes in different regions of the graphene sample;

FIG. 5 is a plot of intensity (arbitrary units) as a function of substrate coordinates x and y;

FIGS. 6A-6F are a schematic illustrations of embodiments of operations performed to correct a material sample image for non-uniform illumination;

FIGS. 7A-7B illustrate embodiments of background subtraction; (7A) range of red, green, and blue light intensity corresponding to few layer graphene regions; (7B); optical image after background subtraction and removal of regions having greater than a selected number of layers;

FIG. 8 illustrates the range of grayscale values associated with specific identified layers for an embodiment of a graphene material;

FIG. 9A illustrates the dependency of optical brightness associated with specific identified layers for an embodiment of a graphene material;

FIGS. 9B and 9C illustrate embodiments of images of a graphene material for which single layer graphene (9B) and bilayer graphene (9C) are illustrated in white; and

FIG. 10 illustrates an embodiment of a graphene material for which regions having a single layer, 2-layers, 3-layers, and 4-layers are illustrated in pseudo color.

### DETAILED DESCRIPTION OF THE PREFERRED EMBODIMENT

Embodiments of the present disclosure relate to systems and methods for the detection of a number of layers present in selected thin film materials. In certain embodiments, the materials may comprise layers that are coupled by Van der Waals forces. In further embodiments, the materials may comprise graphene, topological insulators (e.g., Bi₂Te₃, BiSe₃), thermoelectrics (e.g., Bi₂Te₃), mica, materials having a Van der Waals gap and that may be exfoliated, and materials having a Van der Waals gap and that may be grown (e.g., grown by techniques including, but not limited to, chemical vapor deposition (CVD), molecular beam epitaxy (MBE), atomic layer deposition (ALP), and the like. Embodiments of the systems and methods may be discussed below in the context of graphene, however, the embodiments of the disclosure may be applied to any layered materials

The terms “approximately,” “about,” and “substantially” as used herein represent an amount close to the stated amount that still performs a desired function or achieves a desired result. For example, the terms “approximately,” “about,” and “substantially” may refer to an amount that is within less than 10% of, within less than 5% of, within less than 1% of, within less than 0.1% of, and within less than 0.01% of the stated amount.

Embodiments of the present disclosure provide systems and methods for material layer identification and quality control that is automated, cheap, robust, high-throughput, time-effective, and highly efficient over relatively large areas. In certain embodiments, the detection technique may include acquiring an image of a material sample having a single layer or few layers (e.g., 1-10 layers) in an electronic image format. The image may be acquired using one or more of visible wavelengths of light, non-visible light wavelengths, and particles (e.g., electrons). The image may be further represented in a selected color space (e.g., Red, Green, Blue).

The detection technique may further include a calibration operation. As discussed in greater detail below, the calibration operation may identify the correlation between the number of layers present in an electronic image of a calibration sample of a selected layered thin film material (e.g., 1 layer, 2 layers, 3 layers, 4 layers) to a range of values for one or more parameters of the components of the color space (e.g., the intensity of each of R, G, and B) of the electronic image. The detection technique may further include one or more image processing operations that enable identification of regions of the material sample with different numbers of atomic planes or layers.

Optionally, the detection technique may further include one or more operations that remove information from the electronic image prior to identification of the number of layers within the material sample in order to facilitate identification of different layers within the material sample. In one embodiment, a background subtraction operation may be performed on the electronic image to remove any features of the electronic image associated with the substrate. In another embodiment, a correction may be applied to the electronic image to remove any effects due to non-uniform lighting. In further embodiments, information regarding portions of the electronic image displaying graphene having more than a selected number of layers and/or portions of the electronic image displaying graphite may be removed. After identifying the number of layers, The electronic image may be further manipulated in order to better display the detected layers of the material sample. Selected filtering operations may also be performed in order to refine the layer detection.

Calibration may be carried out using detection techniques capable of identifying a number of layers within the material sample. Examples of such techniques may include, but are not limited to, micro-Raman spectroscopy and atomic force microscopy (AFM). Micro-Raman spectroscopy and AFM are non-destructive techniques that are reliable and accurate for determining a number of layers present in a material sample (e.g., graphene). While it would be prohibitively time consuming to acquire Raman spectrum or AFM data from a large area sample, each may be employed to detect a number of layers in a material sample over a small scanning spot size (e.g., a few microns). In combination with a measurement of the intensity of the color components of the electronic image of the material sample in the same area, a range for one or more parameters of the color components (e.g., intensity) may be calibrated to a selected number of layers present in the material sample. Once this calibration is performed, it may be used for layer detection in other samples of the layered, thin film material, provided the calibration material and the sample material are the same, the sample material is positioned upon the same substrate as the calibration material (if the calibration is performed using a layered, thin film material positioned on a substrate), and the illumination conditions (e.g. source light intensity, wavelength) used to image the calibration sample are the same as that employed for the calibration sample in the sample material.

Operations that remove information from the electronic image that does not pertain to a selected number of layers of graphene may include background subtraction and corrections for non-uniform illumination of the material sample. Background subtraction may be employed to remove information within the electronic image that is due to contributions from the substrate. Non-uniform illumination corrections reflect the realization that illumination on the material sample is not uniform due to circular confocal lens aberrations introduced by an imaging device (e.g., a microscope). that is used to acquire the electronic image of the sample. In further embodiments, information regarding portions of the graphite having more than a selected number of layers may be removed from the electronic image. Because features of the electronic image not pertaining to the layers of the sample material are removed, the layers of the sample material may be more easily identified

Operations may be further performed on the electronic image to facilate identification of layers of the material sample. In certain embodiments, the image processing operations may be performed on an electronic image that has been subjected to background subtraction and/or non-uniform illumination correction. The image processing operations may optionally include a segmentation operation where each pixel in the electronic image is converted from its original color space to a grayscale color space. The range of color space values corresponding to different numbered layers that were acquired from the calibration process may also converted to a monochromatic color scale (e.g., grayscale). The color values of the monochromatic electronic image may be compared to the calibrated ranges of monochromatic color values in order to determine the number of layers present in different areas of the monochromatic electronic image. It may be understood that, while conversion of the electronic image and correlation to a monochromatic scale is not needed for layer detection (as the original colored electronic image and attendant correlation may be employed for layer detection), monochromatic color values may be easier to work with, as layer identification can be achieved using one parameter, rather than multiple values (e.g., 3 color component values in the RGB color space).

Image manipulation that facilitate display the detected layers of the material sample may also be performed. In one example, selected pseudo colors may be applied to the detected material layers. In another example, a three-dimensional projection of the detected materials may be generated. Other image manipulation operations may be performed, alone in combination, to facilitate display of the different detected material layers.

In certain embodiments, further operations may be performed on the electronic image before or after pseudo colors are applied to the electronic image. A first noise reduction operation may require that a minimum number of similar pixels (e.g., pixels having grayscale or pseudo color values within a selected range) are adjacent one another in order for a region to be identified as being a material layer. A second noise reduction operation may apply a median filter to the analyzed electronic image. For example, a selected pixel in the electronic image may be selected. The color values assigned to a selected number of pixels in the region about the selected pixel may be examined to determine the median color values of the nearby pixels. The selected pixel may be assigned color values that are the median of the color values of the pixels nearby the selected pixel. In this manner, the display of the electronic image may be smoothed.

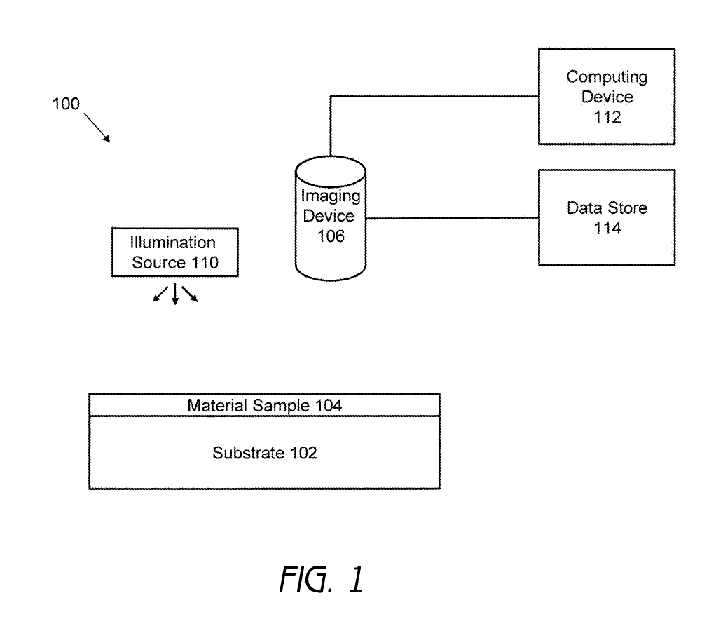

An embodiment of a system 100 for layer detection in samples of layered, thin film materials is illustrated in FIG. 1. FIG. 1 illustrates a substrate 102 upon which a sample 104 of a layered, thin film material is positioned. An imaging device 106, an illumination device 110, and a calibration device 111 may be positioned with respect to the material sample 104 and the substrate 102. The imaging device 106 and/or calibration device 111 may also be in communication with a computing device 112.

Embodiments of the substrate 102 may include, but are not limited to, plastics (e.g., polymethylmethacrylate (PMMA)), composites, metals, insulators and semiconductors. Examples of semiconductors may include, but are not limited to, gallium arsenide (GaAs), indium phosphide (InP), germanium (Ge), silicon (Si), silicon dioxide (SiO₂), glass, Gallium Nitride (GaN), Gallium Arsenide (GaAs), Indium Phosphorous (InP) and related heterostructures. The heterostructures may include, but are not limited to, Gallium Arsenide Indium Phosphorus (GaAsInP) and the like. In alternative embodiments, the material sample may be suspended by itself. For example, the material sample may be suspended in air, in a liquid, over a trench, etc.

Embodiments of the material sample 104 may include materials that are mechanically exfoliated from a bulk material and materials that are grown. In certain embodiments, the material sample 104 may include, but are not limited to, graphene, topological insulators, thermoelectrics (e.g, Bi₂Te₃, Bi₂Se₃, chalcogenides, skutterudite thermoelectrics, oxide thermoelectrics), mica, materials having a Van der Waals gap and may be exfoliated, materials having a Van der Waals gap and may be grown (e.g., grown by chemical vapor deposition (CVD), molecular beam epitaxy (MBE), atomic layer deposition (ALP), and the like. Examples of topological insulators may include, but are not limited to, compounds of the form BiₙSb₁₋ₓ(e.g., Bi₂Se₃), Bi₂Te₃, LnAuPb, LnPdBi, LnPtSb, and LnPtBi. Examples of chalcogenides may include, but are not limited to, bismuth chalcogenides (e.g., Bi₂Te₃, Bi₂Se₃), lead chalcogenides (e.g., lead compounds of the form PbₙBi₂Seₙ₊₃, such as PbₙBi₂Se₄, and of the form PbₙSb₂Teₙ₊₃, such as Pb₂Sb₂Te₅). Examples of skutterudite thermoelectrics may include, but are not limited to, These structures are of the form (Co,Ni,Fe)(P,Sb,As)₃. In certain embodiments, these skutterudite thermoelectrics may be cubic with space group Im3. Unfilled, these skutterudite thermoelectrics may also contain voids into which low-coordination ions (e.g., usually rare earth elements), may be inserted. Examples of oxide thermoelectrics may include, but are not limited to, homologous compounds (e.g., compounds of the form (SrTiO₃)ₙ(SrO)ₘ). Further embodiments of thermoelectrics may include PbTe/PbSeTe quantum dot superlattices. Additional embodiments of layered, thin-film materials may include MoS₂, WS₂, MoSe₂, MoTe₂, TaSe₂, NbSe₂, NiTe₂, BN, and Sb₂Te₃.

In an embodiment, the imaging device 106 may be employed to image the material sample 104 and/or the substrate 102. In certain embodiments, the imaging device 106 may include hardware and/or software enabling capture of images representing the material sample 104 and/or the substrate 102. In alternative embodiments, the imaging device 106 may be in communication with an electronic device capable of image capture (e.g., a camera).

In one embodiment, the imaging device 106 may comprise imaging devices capable of capturing images of the material sample 104 in visible light wavelengths (e.g., microscopes, cameras, and the like). As discussed in greater detail below, a selected color space may be selected to represent the material sample 104 and/or the substrate 102 in the visible colors acquired by the optical imaging devices.

In other embodiments, the imaging device 106 may comprise one or more devices capable of capturing images of the material sample using non-visible light wavelengths or particles (e.g., electrons). Images captured using non-visible light wavelengths may be represented in a selected color space, as understood in the art. Examples of such imaging devices 106 may include, but are not limited to, Low Energy Electron Microscopes (LEEM), Atomic Force Microscopes (AFM), Scanning Electron Microscopes (SEM), Transmision Electron Microscopes (TEM), Scanning Tunneling Microscopes (STM), Photoelectron Microscopes, Photoemission Electron Microscopes, X-Ray Imaging Devices, and Infrared Imaging Devices.

As discussed in greater detail below, the color image of the material sample 104 and/or the substrate 102 may be correlated to a number of layers within the layered material. The imaging device 106 may, therefore, further include devices capable of identifying a number of layers of a layered material. Examples of such devices may include Raman spectrometers and Atomic Force Microscopes. Techniques for imaging and identifying a number of material layers within a layered material sample such as graphene using Raman Spectroscopy may be employed as discussed within A. C. Ferrari, et al., “Raman Spectrum of Graphene and Graphene Layers,” Phys. Rev. Lett. 97, 187401-1-187401-4 (2006), which is hereby incorporated by reference in its entirety. Techniques for imaging and identifying a number of material layers within a layered material sample such as graphene using AFM may be performed in accordance with one or more of K. S. Novoselov, et al., “Two-dimensional atomic crystals,” PNAS, 102(30) 10451-10453 (2005) and C. H. Lui, “Ultraflat graphene,” Nature Lett., 462 339-341 (2009), the entirety of each of which are hereby incorporated by reference.

In certain embodiments, the material sample 104 may be further illuminated with the illumination source 110 to facilitate imaging. For example, at least a portion of the material sample 104 (e.g., a selected region of interest) may be illuminated substantially uniformly. In certain embodiments, the illumination source 110 may emit light having one or more wavelengths that vary within selected ranges between visible light (e.g., about 390 nm to about 750 nm), infrared light (e.g., about 700 nm to about 300,000 nm, ultraviolet light (e.g., about 10 nm to about 400 nm), X-ray wavelengths, and the like. Other wavelengths are also possible. In alternative embodiments, the illumination source 110 may emit particles, such as electrons, for imaging the material sample 104.

Embodiments of the illumination source 100 may include, but are not limited to, light emitting diodes (LEDs), organic light emitting diodes (OLEDs), incandescent lights, fluorescent lights, and plasma lighting. In further embodiments, the light source may be filtered light, for example, frequency filtered light. In further embodiments the light source may be polarized light, for example, circularly or linearly polarized light.

Embodiments of the substrate 102, material sample 104, lighting source 106, and imaging device 106 may each be configured so as to facilitate visibility of the material sample 104. Embodiments of techniques for improving the visibility of graphene may be employed as discussed in P. Blake, et al., “Making Graphene Visible,” Appl. Phys. Lett. 91 063124-1-063124-1 (2007) and G. Teo, et al., “Visibility study of graphene multilayer structures,” J. Appl. Phys. 103 124302-1-124302-6 (2008), each of which are hereby incorporated by reference in their entirety.

For example, graphene sheets may appear substantially transparent under an optical microscope. However, due to interference patterns on the substrate, SLG and FLG may appear visible due to constructive interference. In one embodiment, a silicon dioxide on silicon substrate (Si/SiO₂) may be employed having an SiO₂ thickness of approximately 300 nm. A white light illumination source may be further employed to illuminate graphene, such as a quartz tungsten halogen illumination source. In this configuration, few-layer graphene regions may be visualized under ambient light conditions.

A calibration device 111 may also be employed for making calibration measurements on a calibration sample (a sample of a selected layered, thin film material selected for use in calibration operations) as discussed in greater detail below. Embodiments of the calibration device 111 may include, but are not limited to, Raman spectrometers and AFMs.

The imaging device 106 and/or calibration device 111 may be in further communication with the computing device 112 and the data store 114. The computing device 112 may be configured for analysis of captured images of the material samples 104 for calibration and/or layer analysis. Examples of computing devices 112 may include, but are not limited to, personal computers, laptop or tablet computers, personal digital assistants (PDAs), hybrid PDAs/mobile phones, mobile phones, electronic book readers, set-top boxes, and the like.

The data store 114 may include network-based storage capable of communicating with any component of the system 100 (e.g., the imaging device 106, calibration device 111, and/or computing device 112). In certain embodiments, the data store 114 may further include one or more storage devices that may communicate with other components of the system 100 over a network, as discussed below. The data store 114 may further include one or more storage devices that are in local communication with any component of the system 100.

Communication between the imaging device 110, the computing device 112, and/or the data store 114 may be performed over a network. Those skilled in the art will appreciate that the network may be any wired network, wireless network, or combination thereof. In addition, the network may be a personal area network, local area network, wide area network, cable network, satellite network, cellular telephone network, or combination thereof. Protocols and components for communicating via the Internet or any of the other aforementioned types of communication networks are well known to those skilled in the art of computer communications and, thus, need not be described in more detail herein. In alternative embodiments, communication may be performed using portable computer readable media (e.g., floppy disks, portable USB storage devices, etc.).

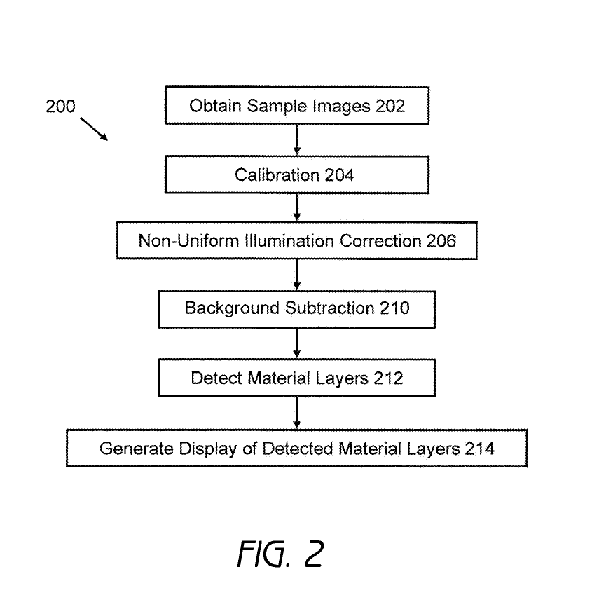

FIG. 2 is a flow diagram illustrating one embodiment of a method 200 for material layer detection. The method 200 includes an operation 202 in which a sample image is obtained, a calibration operation 204, an operation 206 in which non-uniform illumination is corrected, a background subtraction operation 210, a material layer detection operation 212, and one or more operations 214 for display of the detected material layers. It may be understood, however, that one or more of these operations may be omitted from the method 200 and the operations of the method 200 may be performed in any order, as necessary.

In block 202, electronic sample images may be obtained. In one embodiment, images of the material sample 104 may be obtained. In certain embodiments, the material sample 104 may be positioned upon a substrate 102. In alternative embodiments, the material sample 104 may be suspended by itself and no substrate is present. In one embodiment, the substrate 102 may be SiO₂ on Si, with an SiO₂ thickness of about 300 nm. In further embodiments, the material sample 104 may be graphene produced by mechanical exfoliation from highly ordered pyrolytic graphite HOPG. The material sample may be further that is placed on top of the Si/SiO₂ substrate. The material sample 104, with or without the substrate 102, may be further illuminated from an illumination source 110 that provides white light.

Images of the substrate 102 alone (when present) and the material sample 104, may be acquired by a camera in optical communication with the imaging device 106. In alternative embodiments, where the material sample 104 is suspended, images of the material sample 104 alone may be obtained. The images of the material sample 104, and optionally the substrate 102, may be employed for layer detection as discussed below.

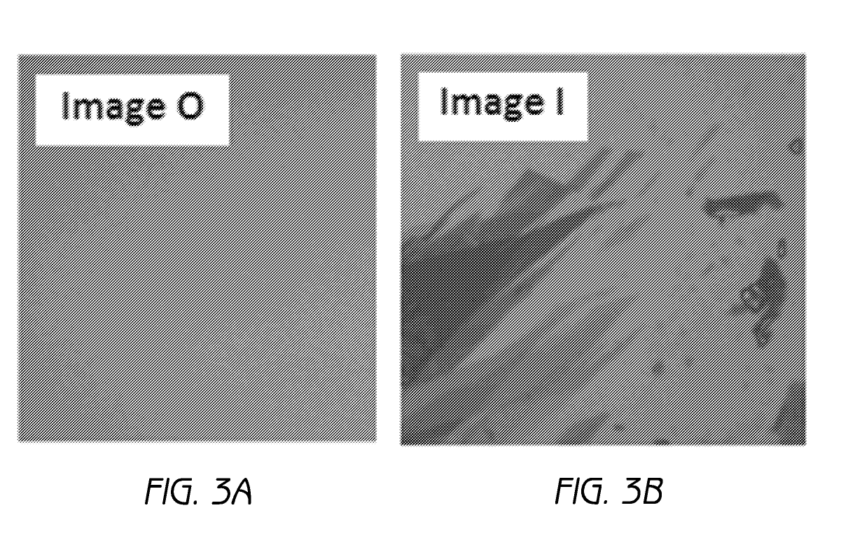

An example of images of the substrate 102 and the material sample 104 captured under these conditions is illustrated in FIGS. 3A-3B. As discussed herein, the image of the substrate 102, without the material sample 104, may be referred to as Image O and the image of the material sample may be referred to as Image I. The Images O and I may be represented in a selected color space having component colors. Examples of colors spaces may include, but are not limited to, RGB, CMYK, CIE, HSV, HSL, YIQ, YUV, YDbDr, YPbPr, YCbCr, xvYCC, monochrome color spaces, and other colors spaces known to those of skill in the art. It may be understood that images of the substrate 102 and the material sample 104 may also be retrieved from the data store 114.

In an embodiment, a parameter of the components of the color space for each pixel within the Image O and Image I may also be determined. For the purposes of example, the parameter of intensity will be discussed below. It may be understood, however, that other components of the selected color space may be employed without limit. Each image can be divided into a matrix of pixels with dimensions M×N, where pixel row and column locations are in the range of x, yε0≦x≦M, 0≦y≦N. Each pixel may be further assigned a light intensity in the range Iₘᵢₙ≦I(x, y)≦Iₘₐₓ for a given light source intensity. Here, Iₘₐₓ is the maximum intensity allowable (e.g., 255), and Iₘᵢₙ is the minimum intensity allowable (e.g., 0), while x and y indicate the row and column (or coordinates) of the locations being computed. In an embodiment, the intensity of each pixel, I(x,y) can be represented in the RGB color space as a combination of red (R), green (G), and blue (B) intensity values, I(x, y)=[I_{R}(x, y), I_{G}(x, y), I_{B}(x, y)], where I_{R} is the red intensity value, I_{G} is the green intensity value and I_{B} is the blue intensity value. The color value components for Image O and Image I may be stored for use in subsequent image analysis.

In block 204, calibration operations may be performed. In one embodiment, calibration operations may be performed over a first region of a material sample 104 and the calibration may be applied to a second region of the material sample 104 to determine the number of layers within the second region of the material sample. In alternative embodiments, obtained images of a first substrate 102 and/or first material sample 104 may be used as calibration images and correlations derived from these first obtained images may be applied to a second material sample 104 for which layer detection is desired.

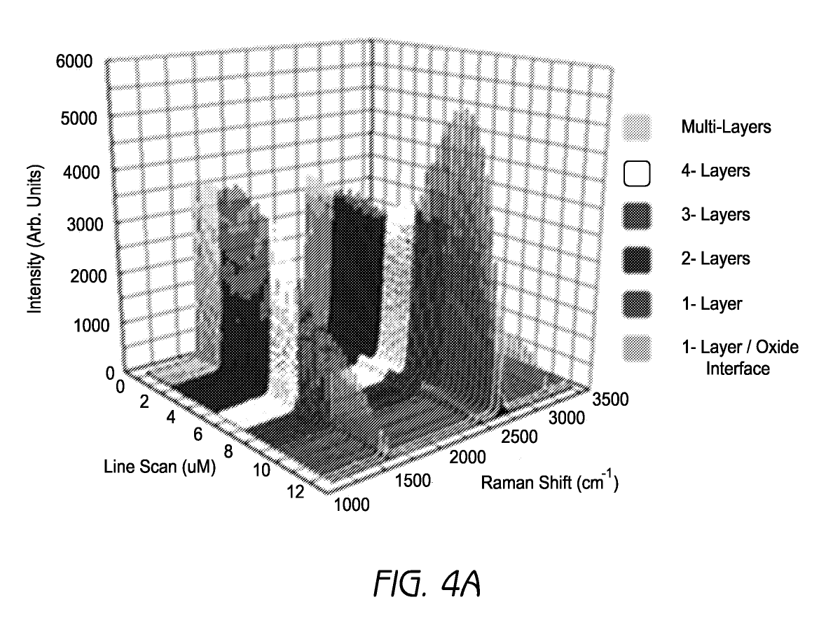

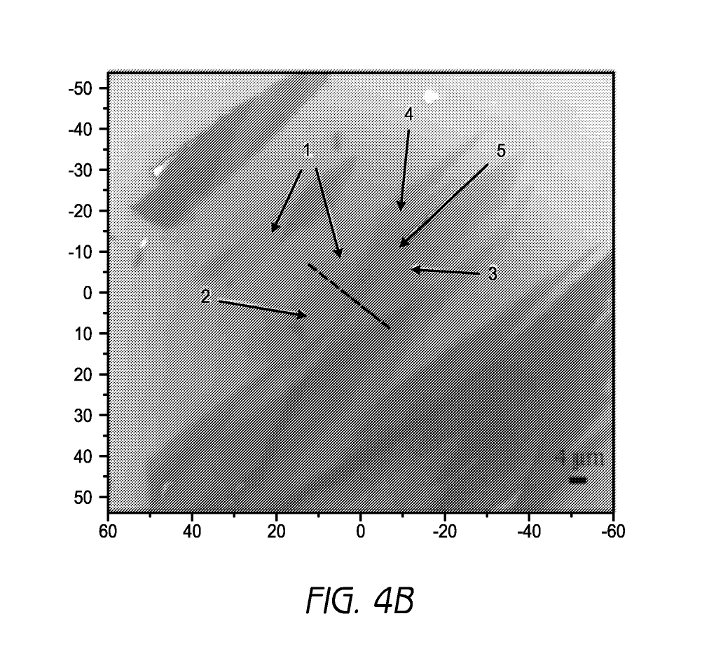

The calibration operations may be performed using techniques such as Raman spectroscopy or AFM on a selected region of the material sample 104, as illustrated in FIG. 4A. For the purposes of example, Raman spectroscopy will be discussed below. Raman spectroscopy has proven to be very reliable for identification of material layers, such as SLG and FLG with a number of layers, n, of one, two, three, four, and five via convolution of the 2D band and measuring the ratio of the intensities of the G band to 2D band, as described above in A. C. Ferrari, et al. In general, a single line scan may be sufficient to identify at least one spot for each n. The coordinates of the spots, corresponding to n=1, 2, 3, 4, and 5 may be recorded and correlated with color information for the same location from Image O and Image I.

The calibration operations 204 enable the number of atomic planes within selected regions of the material sample 104 to be identified and labeled, as illustrated in FIG. 4B. The region of the material sample 104 upon which calibration is performed is a region where the presence of single of few layers of the material sample 104 are believed to be present. For example, a preliminary estimation of the presence of single or few layers of the material sample may be obtained from visual inspection of the material sample 104.

Beneficially, the calibration operations do not take much time because they are performed on a small region of the calibration samples and do not need to be repeated over the whole calibration sample. Furthermore, once the calibration operation 204 is performed for the calibration sample on a certain substrate it can be omitted for each new material sample 104 if the substrate 102 and light conditions are kept the same. In certain embodiments, the Raman calibration may be verified via atomic force microscopy (AFM).

In block 206, the component color values of an Image I for which layer detection is desired may be corrected in order to account for non-uniformities in illumination of the substrate 102 and material sample 104. In certain embodiments, Image I may be a different Image I that was used for calibration or may be a different region of the sample material sample 104 within an Image I used for calibration. For example, optical images taken using optical microscopes may be unavoidably affected by the objective lenses, which do not produce uniform intensity of lighting throughout the images.

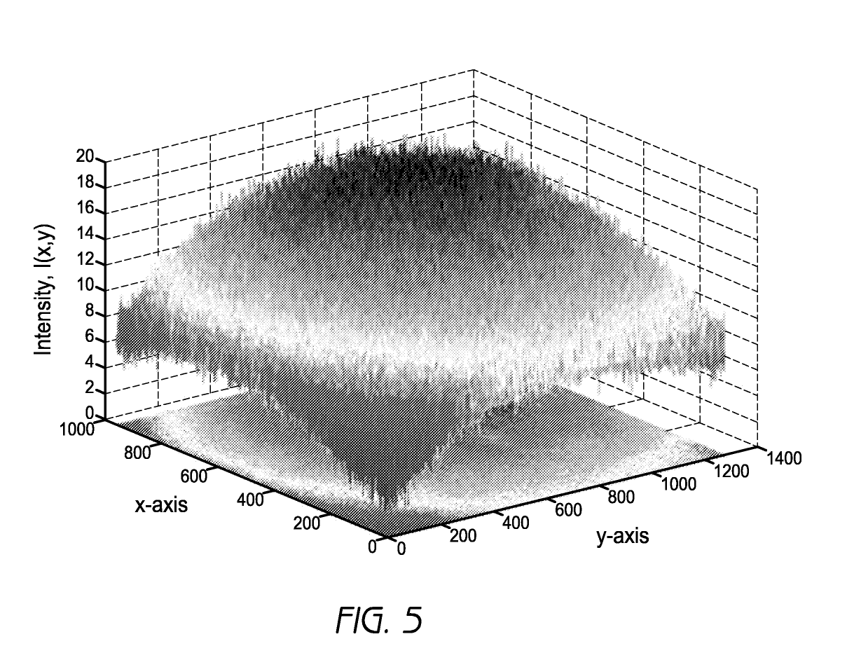

The non-uniform illumination correction may be performed using the light intensity measured for the substrate image (Image O), illustrated in FIG. 5. As shown in FIG. 5, the light incident on the substrate 102 is at its maximum intensity at about the focal center and is at its minimum intensity at about the corner edges of the image. In general, the intensity profile obtained from Image O may be subtracted from Image I for which layer detection is desired in order to correct this Image I for non-uniform illumination. This equalizes the lighting conditions over the whole substrate for the following image processing steps.

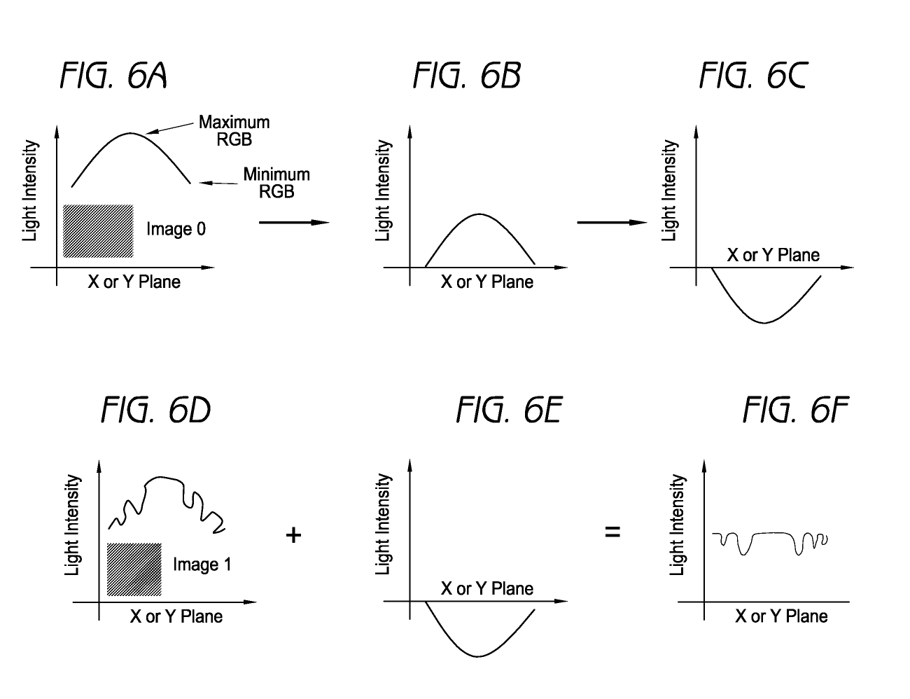

The operations for non-uniform illumination correction may be further understood in conjunction with FIG. 6 and accompanying description below. The light intensity distribution for Image O along the x or y axis may be determined. As discussed above with respect to FIG. 5 and further illustrated in FIG. 6A, this intensity distribution is non-uniform with the maximum attained usually around the center of the image. The intensity distribution may be modified by subtraction of the uniform background (FIG. 6B). The resulting non-uniform part may be inverted and stored for further use with the Image I for which layer detection is desired (FIG. 6C). As illustrated in FIG. 6D, the intensity distribution for Image I for which layer detection is desired (the actual material sample on the substrate) may also be accumulated. The addition of the inverted light intensity, obtained for the reference Image O (FIG. 6E), to the intensity distribution in Image I for which layer detection is desired results in the corrected intensity distribution this Image I with eliminated lighting non-uniformity (FIG. 6F)

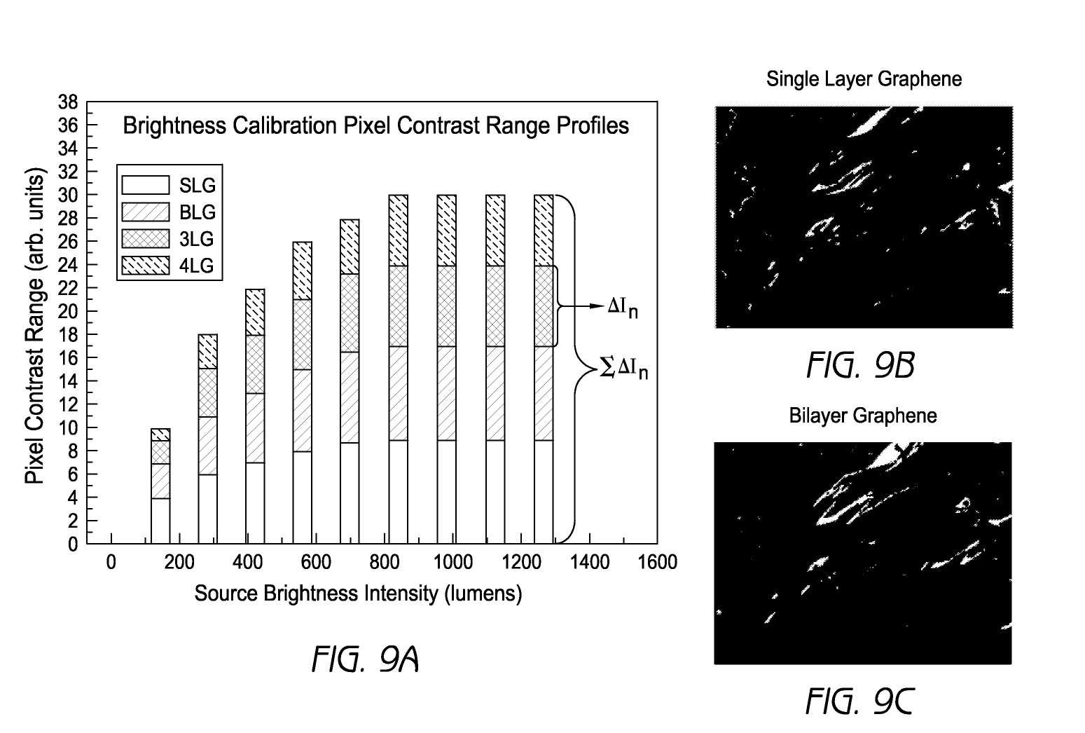

Mathematically, this process may be described as an application of a lens modulation transfer function (L_{MTF}) filter. The filter corrects the circular lens aberration produced by the Gaussian-like distribution of non-uniform light intensity in both the x and y planes of Image I (see FIGS. 4 and 9). The application of the L_{MTF} filter may be performed with the equation:

I_{n,CεR,G,B}(x,y)=I_{CεR,G,B}(x,y)−L_{MTF} (1)

for each value I_{R}, I_{G}, I_{B}, where L_{MTF}=O_{CεR,G,B}(x, y)−min(O_{CεR,G,B}). The intensity function Iₙ now contains the corrected image with the evenly distributed light intensity across the entire image (FIG. 6F).

The background subtraction operation 210 may be performed on the Image I for which layer detection is desired that is corrected for non-uniform illumination. In one embodiment, the background contribution to the Image I from the substrate may be removed. For example, the RGB values from all pixels that correspond to the same location in Image O and the Image I for which layer detection is desired may be subtracted. If the result is approximately 0, then the pixel in Image I for which layer detection is desired is assumed to be a background pixel. In this case the RGB pixel value in Image I for which layer detection is desired under consideration may be changed to white (e.g., corresponding to (0, 0, 0). If the result of the subtraction is non-zero, then the pixel in Image I is assumed to not be a background pixel. In this case, the RGB pixel value is not changed in Image I and instead retains its original RGB value. This subtraction operation may be mathematically represented as:

$$M ( x , y ) = \{ \begin{matrix}0 & if {O}_{C ∈ R , G , B} ( x , y ) - {I}_{C ∈ R , G , B} ( x , y ) \approx 0 \\ \neq 1 & if {O}_{C ∈ R , G , B} ( x , y ) - {I}_{C ∈ R , G , B} ( x , y ) \neq 0 ,\end{matrix} \qquad ( 2 )$$

where M contains the filter resulting from Image I for which layer detection is desired, with the substrate background subtracted.

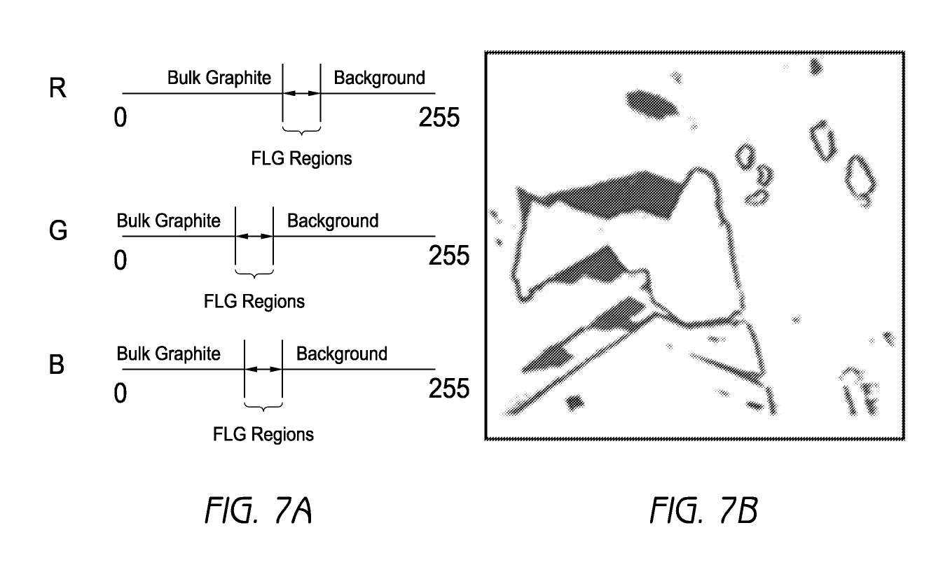

The Image I for which layer detection is desired may be further processed to remove portions of the image that are not one of the layers detected from the calibration operation 204, as illustrated in FIGS. 7A-7B. From the calibration operation 204, the RGB values corresponding to different layers of the material sample are known. For example, assume that five layers, n=1, 2, 3, 4 and 5, are identified in the calibration operation. Further assume that only identification of regions of the Image I for which layer detection is desired having five or less layers is desired. Using the correlation between the RGB values and respective layers, Regions of the Image I for which layer detection is desired that have RGB color values that do and do not fall within one of ranges for n=1, 2, 3, 4 and 5 may be identified. For example, FIG. 7A illustrates RGB color values that are identified to belong to one of ranges for n=1, 2, 3, 4 and 5 in a graphene sample (FLG). As these regions are not associated with one of the detected layers, they may also be safely removed from Image I for which layer detection is desired without affected the image information of the detected layers. For example, the pixel values within the regions not associated with one of the detected layers may be set to white. In this manner, regions thicker than the maximum number of layers detected (e.g., 5) may be removed from the Image I for which layer detection is desired. As illustrated in FIG. 7B, only the dark regions include layers of a graphene material of Image I having five layers or less are displayed. All other regions of the Image I for which layer detection is desired, both background and regions thicker than five layers, are shown as white.

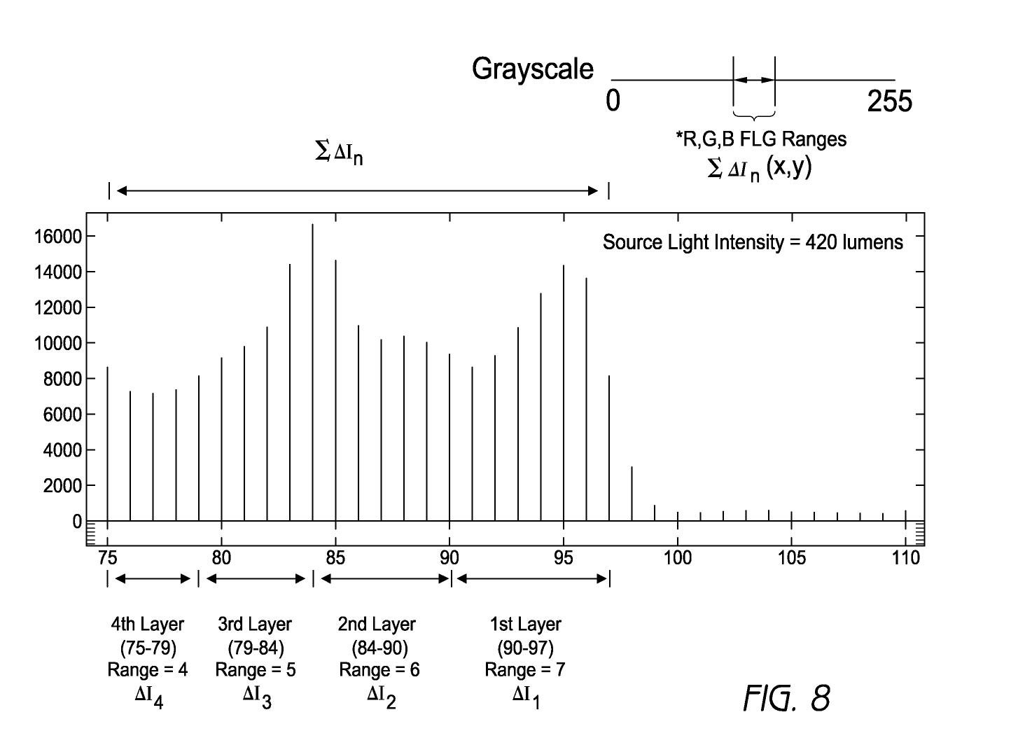

In block 212, identification of each material layer (with specific n) may be from the dark regions remaining in Image I. In one embodiment, the component color value data (e.g., RGB data) for each of the pixels contained within the dark regions remaining in Image I may be converted to a grayscale value. Furthermore, the range of grayscale values associated with each of the layers, referred to as ΔIₙ, and the range of grayscale values from the minimum to maximum grayscale values for the identified layers maximum may also be identified, referred to here as ΣΔIₙ, may be obtained. An example of the ranges ΔIₙ and ΣΔIₙ are illustrated in FIG. 8.

The grayscale conversion may be accomplished through a process called segmentation. For example, the grayscale value may be calculated as a weighted sum of the R, G, and B color values. Equation 3, below, presents an example of such a weighted sum:

I_{n,Gry}=0.30I_{n,R}+0.59I_{n,G}+0.11I_{n,B} (3)

It may be understood that alternative embodiments of grayscale conversion may be performed using different weighting parameters than those illustrated in FIG. 3 or conversion equations different from that of Equation 3, as known in the art.

The optical adsorption of each graphene layer for different brightness intensities is shown in FIG. 8, where ΔIₙ contains the range of the light intensity values associated with a specific material layer of interest (e.g., specified by a given n) and ΣΔIₙ shows the light intensity range of values for the entire range of all material layers of interest. The range of these light intensity values depends on the brightness of the light source of the optical microscope.

It may also be appreciated that ΔIₙ may depend upon the intensity of the light source. For example, FIG. 9A, illustrates the optical brightness ΔIₙ associated with a specific graphene layer of interest, defined by n, where SLG represents a single graphene layer region having n=1, BLG represents a bilayer graphene region having n=2, 3LG represents a graphene layer region having n=3, and 4LG represents a graphene region having n=4. As shown in FIG. 9A, as the brightness intensity increases from about 150 lumens to about 1300 lumens, the relative pixel contrast for different layers changes. Furthermore, these changes appear to occur over the range of about 150 lumens to about 700 lumens before becoming approximately constant.

In certain embodiments, to enhance visual recognition of the different layers, the electronic image may be filtered so as to display only the regions of a single layer. For example, the calibration intensity ranges may be employed to filter out separately the regions for n=1, n=2, n=3, n=4, and n=5 from the grayscale region. FIGS. 9B-9C illustrates how such filtering results in the separated regions in a graphene sample. FIGS. 9B and 9C illustrate Image I filtered for SLG regions (n=1) and BLG regions (n=2), respectively, where the white regions represent the identified SLG and BLG regions, while the dark regions represent areas of the sample material 104 without graphene or are regions having a different number of layers than that of interest (e.g., 1, as in FIG. 9B). The entire M×N transparent image with identified pseudo colored regions may be then laid on top of the original optical image (Image I), for visual identification of regions of the Image I having a desired n.

The display generation operation 214 may include application of a median filter and/or utilization of pseudo colors for better visualization to the Image I that has been subjected to layer identification, as discussed above with respect to FIGS. 9B and 9C. The median filtering step may include a statistical pixel-to-pixel neighboring analysis technique to improve the image resolution within the identified region and to clarify the boundaries between any two regions with different number of atomic planes n Beneficially, the application of a median filter allows removal of high frequency impulse noise commonly known in image processing as “salt and pepper” noise. In our approach, this noise may cause the identified regions of graphene to appear patchy reducing the accuracy when determining the borderlines of the regions.

In one embodiment, the median filter for each individual layer may be implemented. The median filter compares a matrix of n×n pixels of a layer mask (e.g. a mask that identifies which pixels of Image I belong to a selected number of layers) and chooses either to mask a pixel or not. Individual filter passes may be performed for each graphene layer. Beneficially, this removes impulse noise and smooths identified regions. The median filter may be represented mathematically using Equations 5 and 6:

$${M}_{F} = \{ {I}_{{T}_{{n}_{jk}}} \vert j ∈ \{ 1 , 2 , … , W \} and k ∈ \{ 1 , 2 , … , H \} \} , \qquad ( 5 )$$

where M_{F} is a median filter of size W×H for a neighborhood of pixels centered at I_{T}_{ₙ} (x, y), j and k are indices of the rows and columns of the matrix and T is a specific layer mask. The median element of the window M_{F} is given by:

$${I}_{{F}_{n}} ( x , y ) = \{ \begin{matrix}{M}_{{F}_{SORT}} [ \frac{m}{2} ] & for an even n \\ {M}_{{F}_{SORT}} [ \frac{m}{2} + 1 ] & for an odd n ,\end{matrix} \qquad ( 6 )$$

where M_{F}_{_{SORT}}[i], i=1, m, m=W×H and I_{F}_{ₙ} is the resulting sample material layer of interest (with given n) after the impulse noise is removed. The median filter analyzes a set number of pixels in a user-defined matrix region to find the median value of the region currently being inspected. After the operation is performed, the filter may be shifted to the next user-defined matrix region until the entire image is analyzed.

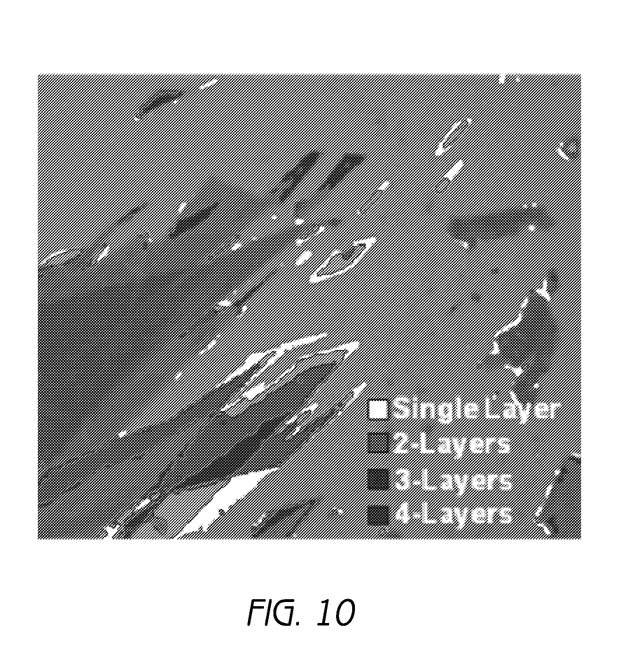

After the filtering process, a pseudo-color may be assigned to each region of the processed Image I with a given n. The processed Image I, may be presented with each layer of interest identified by a unique pseudo color. For example, FIG. 10 illustrates pseudo colors applied to a graphene sample. As shown in FIG. 120, the number of atomic layers at each location of the sample material surface may be clearly indicated in a corresponding pseudo color. An additional first pseudo color may also be applied to the regions of the Image I that represent the substrate itself, without the sample material and an additional second pseudo color may be applied to the regions having more layers than are of interest (e.g., thicker portions of the sample material).

Beneficially, embodiments of the disclosed approach can be extended to wafer size sample materials or sample materials grown on flexible substrates (e.g., CVD graphene). For example, the only size limitation in the embodiments of the disclosed detection method is the area of the optical image. Thus, this approach may be suitable for industry scale high-throughput applications. As embodiments of the detection method are performed by image analysis, layer detection may be performed at high speed for the in situ identification of the number of atomic layers. Thus, the throughput for the industrial scale inspection of many wafers may be determined by the speed of mechanical motion of the wafers to and from the light source. Embodiment of the disclosed detection technique also makes a variety of experimental and industrial applications feasible. For example, in one embodiment, the detection techniques may be applied to a number of various substrates and graphene samples produced by different methods. In another embodiment, calibration techniques other than micro-Raman spectroscopy may be employed. In further embodiments, the disclosed techniques may be employed with a variety of atomically-thin materials, as discussed above.

In certain embodiments, one or more of the processes described herein may be embodied in, and fully automated via software code modules executed by one or more general purpose computers or processors. The code modules may be stored in any type of computer-readable medium or other computer storage device. Some or all the methods may alternatively be embodied in specialized computer hardware. In addition, the components referred to herein may be implemented in hardware, software, firmware or a combination thereof.

Conditional language such as, among others, “can,” “could,” “might,” or “may,” unless specifically stated otherwise, are otherwise understood within the context as used in general to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Although the foregoing description has shown, described, and pointed out the fundamental novel features of the present teachings, it will be understood that various omissions, substitutions, changes, and/or additions in the form of the detail of the apparatus as illustrated, as well as the uses thereof, may be made by those skilled in the art, without departing from the scope of the present teachings. Consequently, the scope of the present teachings should not be limited to the foregoing discussion, but should be defined by the appended claims.

What is claimed is:

1. A computer-implemented method for identifying a number of layers in a layered thin film material, the method comprising:
under control of one or more computing devices:
receiving a first electronic image comprising a representation of at least a portion of a first layered thin film material in a selected color space captured under one or more selected illumination conditions;
determining a correlation between a number of layers of the layered thin film material and a range of color component values of the selected color space;
receiving a second electronic image comprising a representation of at least a portion of a second layered thin film material in the selected color space captured under the one or more selected illumination conditions, wherein the second layered thin film material comprises the same material as the first layered thin film material; and
identifying a number of layers in a selected region of the second electronic image of the second layered thin film material using the determined first correlation.

2. The computer-implemented method of claim 1, wherein the one or more selected illumination conditions comprise one or more of a visible light wavelength of the illumination and a brightness intensity of the illumination.

3. The computer-implemented method of claim 1, wherein the first and second electronic image further comprises a representation of a substrate material upon which the first and second layered thin film materials are positioned.

4. The computer-implemented method of claim 3, further comprising removing at least a portion of the electronic image that is associated with the representation of the substrate from the second electronic image prior to identifying the number of layers in the selected region of the second electronic image.

5. The computer-implemented method of claim 1, wherein the representation of the first and second thin film material comprises an intensity of the components of the selected color space.

6. The computer-implemented method of claim 5, further comprising adjusting the intensity of components of the color space of the second electronic image to add or remove a portion of the intensity of color components of the second electronic image associated so as to correct for non-uniform illumination.

7. The computer-implemented method of claim 1, wherein the first and second layered thin film materials comprises at least one of graphene, MoS₂, WS₂, MoSe₂, MoTe₂, TaSe₂, NbSe₂, NiTe₂, BN, Bi₂Te₃, Bi₂Se₃, and Sb₂Te₃.

8. The computer-implemented method of claim 1, wherein the selected color space comprises the Red-Blue-Green (RGB) color space.

9. A computer-implemented method for identifying a number of layers in a layered thin film material, the method comprising:
receiving an electronic image comprising a representation of at least a portion of a first layered thin film material in a selected color space captured under one or more selected illumination conditions;
determining an intensity range for one or more components of the selected color space that corresponds to a number of layers in a second layered thin film, wherein the second layered thin film material comprises the same material as the first layered thin film material and the intensity range is determined under the one or more selected illumination conditions; and
identifying a number of layers in a selected region of the electronic image of the first layered thin film material using the determined intensity range.

10. The computer-implemented method of claim 9, wherein determining an intensity range comprises:
identifying a number of layers in the second layered thin film material;
obtaining an image of the second layered thin film material under the one or more selected illumination conditions, wherein the electronic image of the second layered film is represented in the selected color space; and
selecting a region of the second layered film within the electronic image; and
correlating the number of layers of the second layered thin film material in the selected region to the component values of the color space representing the second layered film in the selected region.

11. The method of claim 9, wherein the layered thin film material is positioned upon a selected substrate.

12. The computer-implemented method of claim 9, wherein the layered thin film material is graphene, the substrate is SiO₂ upon Si with a SiO₂ thickness of about 300 nm, the illumination is white light of approximately 420 lumens.

13. The computer-implemented method of claim 12, wherein the selected color space is a grayscale color space ranging from 0 to 255, with 0 representing black and 255 representing white and wherein the intensity range corresponding to four graphene layers is about 75 to about 79.

14. The computer-implemented method of claim 12, wherein the selected color space is a grayscale color space ranging from 0 to 255, with 0 representing black and 255 representing white and wherein the intensity range corresponding to three graphene layers is about 79 to about 84.

15. The computer-implemented method of claim 12, wherein the selected color space is a grayscale color space ranging from 0 to 255, with 0 representing black and 255 representing white and wherein the intensity range corresponding to two graphene layers is about 84 to about 90.

16. The computer-implemented method of claim 12, wherein the selected color space is a grayscale color space ranging from 0 to 255, with 0 representing black and 255 representing white and wherein the intensity range corresponding to one graphene layer is about 90 to about 97.

17. The computer-implemented method of claim 9, wherein the thin film layered material comprises at least one of graphene, MoS₂, WS₂, MoSe₂, MoTe₂, TaSe₂, NbSe₂, NiTe₂, BN, Bi₂Te₃, Bi₂Se₃, and Sb₂Te₃.

18. The computer-implemented method of claim 9, wherein the selected color space comprises the Red-Blue-Green (RGB) color space.

19. A system for detecting a number of layers of a layered thin film material, comprising:
a data store that stores one or more correlations between a number of layers of a layered thin film material and ranges of component values of a selected color space; and
a computing device in communication with the data store, the computing device operative to:
obtain the one or more correlations from the data store;
obtain an electronic representation of the layered thin film material in the selected color space; and
identify a number of layers within a selected region of the layered thin film material of the based upon the one or more correlations.

20. The computer-implemented method of claim 19, wherein the electronic image further comprises a representation of a substrate material upon which the first and second layered thin film materials are positioned.

21. The computer-implemented method of claim 20, further comprising removing at least a portion of the electronic image that is associated with the representation of the substrate from the electronic image prior to identifying the number of layers in the selected region of the second electronic image.

22. The computer-implemented method of claim 19, wherein the representation of the layered thin film material comprises an intensity of components of the selected color space.

23. The system of claim 19, wherein the layered thin film material comprises at least one of graphene, MoS₂, WS₂, MoSe₂, MoTe₂, TaSe₂, NbSe₂, NiTe₂, BN, Bi₂Te₃, Bi₂Se₃, and Sb₂Te₃.

24. The system of claim 19, wherein the selected color space comprises the Red-Blue-Green (RGB) color space.
